(19) United States
(12) Patent Application Publication
(10) Pub. No.: US 2012/0319061 A1
(43) Pub. Date: Dec. 20, 2012

(54) Non-inflammable matter-powder and liquid form

(76) Inventor: Manoochehr Shafaei, Hannover (DE)

(21) Appl. No.: 12/592,293

(22) Filed: Nov. 23, 2009

(30) Foreign Application Priority Data
Jul. 6, 2001 (EP) EP 1 069 173 A1

(51) Int. Cl. C09K 21/02

(52) U.S. Cl. 252/601

(57) ABSTRACT

Fire and its discovery was a God-given-gift and played an enormous role in the progress and evolution of the human communities. Nevertheless, despite its vital role, the flame of fire has caused considerable personal injury, financial loss and environmental damage to human communities each year. The present invention relates to compositions for reducing the inflammability of a substrate and to methods for treating the substrate to reduce its inflammability.

This invention is an effective solution to reduce and prevent the above injuries and destructions, while it is non-toxic and environmentally friendly.

Compositions and methods of the invention provide a simple and effective way of reducing the inflammability of a wide variety of substrates. We are proud to say that through this invention we can help save the human race from the calamities and misfortunes due to consequences of fire accidents.

This invention can be applied in liquid or powder forms based on applications and industries needs.

### CROSS REFERENCE TO RELATED APPLICATIONS

Please find the following information which is relevant to the background of this invention:
International Classes: C09K21/00; C09K21/02; HO5K1/03; HO5K1/03; (IPC1-7):
C09K21/02; CO9D5/18; DO6M11/82
European Classes: C09K21/02
Foreign References: GB1242290A

### STATEMENT OF FEDERALLY SPONSORED RESEARCH/DEVELOPMENT

Not Applicable

### REFERENCE TO “SEQUENCE LISTING”

Not Applicable

### BACKGROUND OF THE INVENTION

According to the invention there is provided a composition for reducing the inflammability of a substrate which comprises boric acid, borax and ammonium nitrate. Compositions according to the invention may further comprise water. The components of compositions according to the invention may be in aqueous solution.

The invention can be applied in both liquid and powder form, based on applications and industries needs.

The invention is designed to provide an effective way of making inflammable substrates less hazardous, while ensuring the composition is non-toxic and environmentally friendly.

Please find the following information which are relevant to the background of this invention:
International Classes: C09K21/00; C09K21/02; HO5K1/03; HO5K1/03; (IPC1-7):
C09K21/02; C09D5/18; DO6M11/82
European Classes: C09K21/02
Foreign References: GB1242290A

### BRIEF SUMMARY OF THE INVENTION

The present invention relates to compositions for reducing the inflammability of a substrate and to methods for treating the substrate to reduce its inflammability. Inflammable substrates are hazardous because they are prone to catch fire. Consequently it has been desired to provide an effective way of making these inflammable substrates less hazardous, while ensuring the composition is environmentally friendly.

The invention provides a composition for reducing the inflammability of a substrate which comprises of boric acid, borax and ammonium nitrate.
Compositions according to the invention may further comprise water. The components of compositions according to the invention may be in aqueous solution.

This invention can be applied to applicable manufacturing processes in both forms of liquid or powder; depending on applications and industries needs.

Furthermore; the following standard testing were performed and successfully passed all codes and requirements:
BS EN 20105_BO 2: 1993 Light fastness testing
BS 7837: 1996 Fire test on Fabric
BS EN ISO 105-X 12: 1995 Color fastness to Rubbing
BS EN ISO 105-DO 1: 1995 Color fastness to dry cleaning
EN ISO 6468 esticides and PCB's for Paper, Woods, Textile
EN ISO 10301 highly volatile halogenated hydrocarbons for Paper, Woods, Textile
GC/NP-FID flame retardant for Paper, Woods, Textile
BS 5867 part 2: 1980 Fire tests on fabric for Paper, Woods, Textile
Energy dispersive X-ray analysis Elements for Paper, Woods, Textile

Additional information are listed below, indicating various industries and application relevant to this invention:
Wood Industry:
Wood veneering
Chipboards
Fiber boards
Timber industry
Plywood
Textile Industry:
Fine textile & clothing
Fabrics & upholstery
Industrial fabrics, canvas & jute
Electronic Industry:
Electrical insulators
P.C. Boards
Paper Industry:
Thin papers, stationary & bank note
Industrial papers, Cardboard & carton
Wallpaper
Melamine paper
Paint Industry:
Plastic paint
Other Industries:
Cable industry—All kind of papers and textiles which are used by the cable Industry can be mixed with the liquid solution in order to prevent the spread of fire from inside of the cable to outside and vice versa—specific usage will be indoor cabling and tunnel applications—to prevent spread of fire in an enclosed area.

Automobile industry—All inflammable material used in car industry such as upholstery, floor coverings. Wall & top coverings, card boards and fiberboard layers can be protected with this solution in the event of fire.

Aircraft industry—For fittings, furnishings where fire proofing has to meet the highest standard.

### BRIEF DESCRIPTION OF THE SEVERAL VIEWS OF THE DRAWINGS

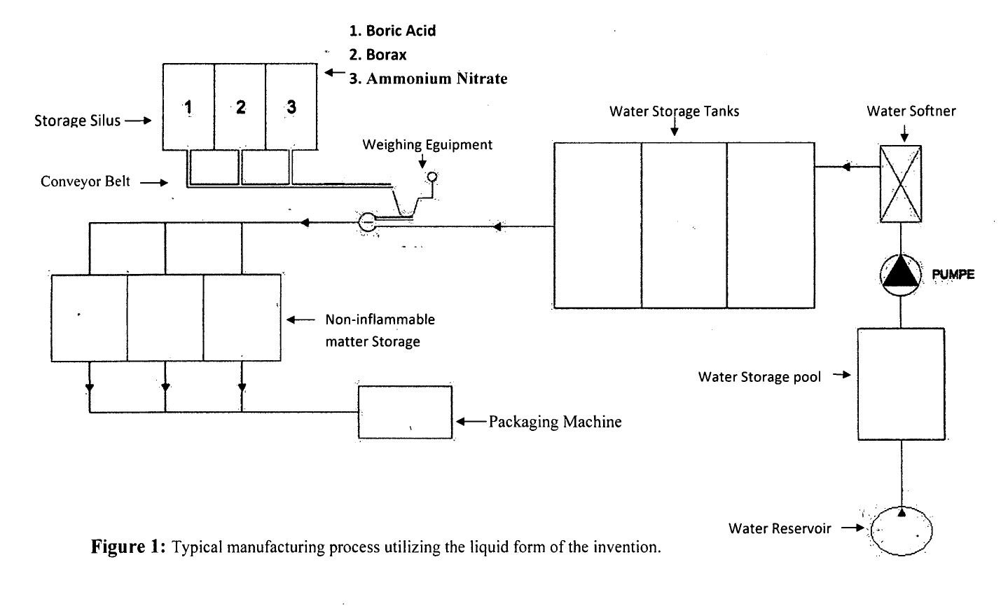

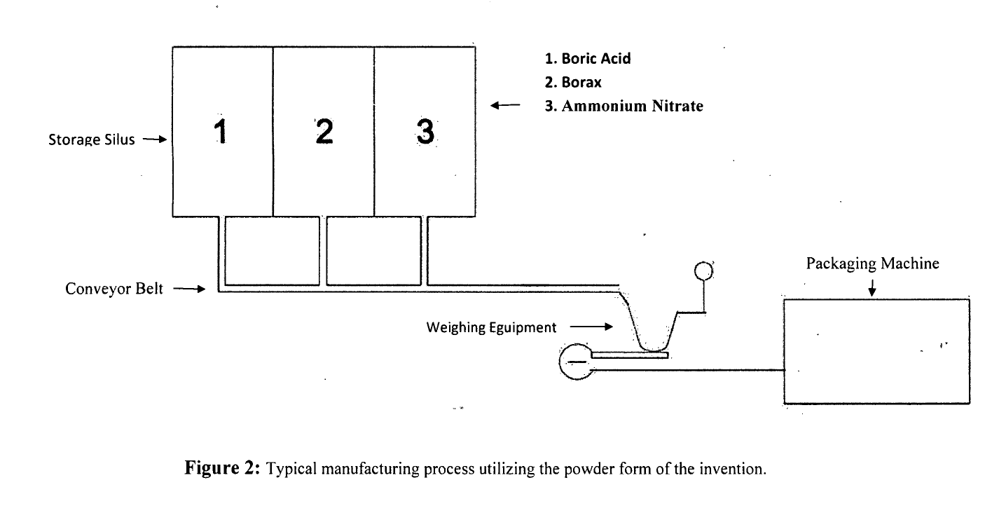

See FIGS. 1 and 2:

### DESCRIPTION OF FIG. 1 INCLUDED IN THE DRAWINGS SECTION

A) Supply of Water
1. Supply and storage of water (for example from the sea, a well or reservoir).
2. Softening of water using a water softener.
3. Storage of water before it is added to a mixer.
B) Supply of Material
1. Storage of up to three components of a composition of the invention in separate storage chambers.
2. Transport of the components of the composition from the storage chambers by a conveyor belt to be weighed separately. 3. Transport of the components to the mixer after they have been weighed.
C) Method of Production in Mixer
1. Addition of water to the mixer, at approximately 20 DEG C. to 70 DEG C.,
2. Entry of the components of the composition to the mixer. The components are weighed and added to the mixer sequentially. After one component has been substantially dissolved in the water, the next is added.
3. Removal of a prepared composition of the invention from the mixer.
4. Storage of the prepared composition.

### Description of FIG. 2 included in the drawings section

FIG. 2 shows a typical block diagram for manufacturing process where it uses the invention in powder forms only, injecting the substance directly into the process:
The block diagram illustrates the simplicity of this process. The storage tanks hold proper portions of each compound—as required and described above for various applications. Inflammable substance mixture will be directly introduced into the system as illustrated above.

### DETAILED DESCRIPTION OF THE INVENTION

The present invention relates to compositions for reducing the inflammability of a substrate and to methods for treating the substrate to reduce its inflammability. Inflammable substrates are hazardous because they are prone to catch fire. Consequently it has been desired to provide an effective way of making these inflammable substrates less hazardous.

According to the invention there is provided a composition for reducing the inflammability of a substrate which comprises boric acid, borax and ammonium nitrate.

Compositions according to the invention may further comprise water. The components of compositions according to the invention may be in aqueous solution.

Preferably boric acid is present in compositions according to the invention from about 2% to about 6%, more preferably from about 2% to about 4.5%, by weight of the composition.

Preferably borax is present in compositions according to the invention from about 3% ₜₒ about 8%, more preferably from about 3% to about 6%, by weight of the composition.

Preferably ammonium nitrate is present in compositions according to the invention up to about 3%, more preferably from about 1% to about 3%, most preferably from about 1% to about 2%, by weight of the composition.

The preferred amount of boric acid, borax or ammonium nitrate in compositions according to the invention may vary depending on the substrate of which the inflammability is to be reduced.

According to the invention there is also provided a method for reducing the inflammability of a substrate which comprises contacting a composition according to the invention with the substrate.

The efficacy of aqueous solutions of compositions according to the invention in decreasing the inflammability of a substrate has been found to be increased if each component of the composition is separately dissolved, at least partially, to form the aqueous solution. This may be done by sequentially dissolving, at least partially, each component of a composition of the invention in the same aliquot of water to form the aqueous solution. The components may be dissolved in any order. Preferably each component is substantially completely dissolved before the next is added. Alternatively, each component may be dissolved, at least partially, in a separate aliquot of water and then the separate aliquots combined to form the aqueous solution. Preferably each component is substantially completely dissolved in the separate aliquots before they are combined.

The length of time for which a substrate is contacted with a composition according to the invention in order to decrease its inflammability may be reduced if the substrate is contacted with the composition at a temperature above room temperature, preferably between 20 DEG C. and 90 DEG C. Alternatively, the degree to which the inflammability of the substrate is reduced may be increased by contacting the composition with the substrate at a temperature above room temperature, preferably between 20 DEG C. and 90 DEG C. These effects may be achieved, for example, by immersing the substrate in an aqueous solution of a composition according to the invention at 20 DEG C. to 90 DEG C. Compositions according to the invention have the following advantages:

The components of the compositions of the invention present no danger to the environment.

Smoke and gases ascending there from during heating and combustion are not poisonous and do not cause pollution.

Substrates soaked in compositions of the invention do not suffer from premature decay or quality weakness.

The compositions of the invention do not cause any skin or internal disease in humans (even if ingested). They do not cause any poisoning or allergy and do not have any other harmful effects.

Other advantages are that the components of the compositions of the invention are easily obtainable and affordable, the production method is simple, and the production rate is high.

With minor modification to the formula, the compositions of the invention are capable of reducing the inflammability of different industrial products (such as wood, paper or textile).

Substrates can readily be treated to reduce their inflammability by simply contacting the substrates with a composition of the invention.

Compositions of the invention do not leave any visible mark on substrates which have been treated according to the invention.

It is possible to present the compositions of the invention in the form of a spray which has a temporary non-inflammable effect, and can be rubbed or washed off.

The quality of a substrate treated with a composition of the invention remains unaltered and is not adversely affected.

A further advantage of the compositions of the invention is that they can be used in different industries and that their effect can be permanent.

With textiles, the non-inflammable effect will be destroyed by complete washing. However, dry cleaning of textiles treated according to the invention does not destroy the non-inflammable effect of the treatment.

Compositions of the invention may be used together with a waterproofing agent. Substrates treated with a composition of the invention mixed with a waterproofing agent have been found to have reduced inflammability and water resistance.
Embodiments of the invention will now be described in detail, by way of example only, with reference to the accompanying drawings in which: FIG. 1 shows schematically a system for producing an aqueous solution of a composition of the invention; and FIG. 2 shows an alternative when using the mixture in powder form of the invention.

Preferred methods for making compositions according to the invention and treating substrates with such compositions to reduce their inflammability are described below: The components of a composition of the invention are stored separately; Water at 20 DEG C. to 90 DEG C. is added to a mixer; The components of the composition are weighed separately and dissolved sequentially in the water in the mixer. Each component is substantially completely dissolved before the next is added; once a composition according to the invention has been prepared, it can be stored, for example, in a concrete chamber or in barrels made from stainless steel or plastic.

FIG. 1 shows a typical block diagram, where the manufacturing process requires the composition to be in liquid form:

A) Supply of Water
1. Supply and storage of water (for example from a well or reservoir).
2. Softening of water using a water softener. 3. Storage of water before it is added to a mixer.

B) Supply of Material
1. Storage of up to three components of a composition of the invention in separate storage chambers.
2. Transport of the components of the composition from the storage chambers by a conveyor belt to be weighed separately. 3. Transport of the components to the mixer after they have been weighed.

C) Method of Production in Mixer
1. Addition of water to the mixer, at approximately 20 DEG C. to 90 DEG C.,
2. Entry of the components of the composition to the mixer. The components are weighed and added to the mixer sequentially. After one component has been substantially dissolved in the water, the next is added.
3. Removal of a prepared composition of the invention from the mixer.
4. Storage of the prepared composition.
Sea water can be used as a source of the water for dissolving the components of compositions of the invention if the sea water is first distilled.

FIG. 2 a block diagram for typical manufacturing process, utilizing the powder form of the invention.

The portions and amount of the compounds depends on the material, industry and other needs and applications described herein.

In the Examples described below, the inflammability of each substrate was found to have decreased after being soaked in the specified composition according to the invention for a total of 1 to 15 minutes.

The treatment of substrates with the compositions of the invention may take place at an appropriate stage in the manufacture of the substrate, depending on the substrate. All products of the industries described below may be treated with an aqueous solution of a composition of the invention after their manufacture is complete and/or during the manufacture process. In the case of tarpaulin, treatment may be before the drying process, and after painting. In the case of fibre, treatment may be at the time of preparation of the fibre mix. In the case of printed circuit boards and in paper or textile manufacture, treatment may be at the beginning of the production process.

Use of Compositions of the Invention in Different Industries:

### EXAMPLE 1

### The Wood Industry

Preferred compositions according to the invention for use in the wood industry comprise 3% to 6% boric acid, 4% to 8% borax and 0.5% to 2% ammonium nitrate, by weight of the composition, and water (vacuum and injection method is to be used for large pieces such as those used in the timber industry). Examples of methods for treating wood are:
i) Wood Veneering Industry
Conventionally, tree trunks are soaked in water to prepare them for cutting. Aqueous solutions of compositions according to the invention may be used instead of water. Such aqueous solutions penetrate the wood of the tree trunks. The inflammability of veneer prepared from the tree trunks is thereby reduced.
ii) Chipboard Industry
Conventionally, wood chips are mixed with resin, then compressed and dried in a furnace to form chipboard. The wood used to prepare the wood chips, the wood chips themselves, or the compressed wood chip/resin mixture may be treated with an aqueous solution of a composition of the invention and dried before continuing with the next stage of the chipboard manufacture process. The inflammability of the chipboard thereby produced is reduced. Alternatively or additionally, the finished chipboard may be treated with an aqueous solution of a composition of the invention.
iii) The Fibreboard Industry
Conventionally, a wood fibre mix is prepared and then compressed to form fibreboard. The inflammability of fibreboard may be reduced if the wood used to make the fibre mix, or the fibre mix itself, is treated with an aqueous solution of a composition of the invention. Alternatively or additionally the finished fibreboard may be treated with an aqueous solution of a composition of the invention.
iv) The Plywood Industry
Conventionally, layers of wood are cut, glued and pressed together with the grain of adjacent layers running in different directions. The inflammability of plywood may be reduced by treating the wood used to make the plywood with an aqueous solution of a composition of the invention before or after it has been cut. Alternatively or additionally, the finished plywood may be treated with an aqueous solution of a composition of the invention.
v) The Panel Industry
The inflammability of wood used to make panels may be reduced by treating the wood with an aqueous solution of a composition of the invention before or after it has been cut. Alternatively or additionally, the finished panels may be treated with an aqueous solution of a composition of the invention.

### EXAMPLE 2

### The Textile Industry

i) The inflammability of different types of soft and delicate textiles (for example, textiles for use as furniture covering, curtains, or normal fabric) can be reduced by treating the textile with an aqueous solution of a composition of the invention. Preferred compositions according to the invention for treating such textiles comprise 2 to 4% boric acid, 3 to 5% borax, 1% ammonium nitrate, by weight of the composition, and water.
ii) The inflammability of thicker textiles (such as tarpaulin and sackcloth) may be reduced by treating the textile with an aqueous solution of a composition of the invention. Preferred compositions according to the invention for treating such textiles comprise 2 to 4% boric acid, 3 to 5% borax, 1 to 2% ammonium nitrate, by weight of the composition, and water.

### EXAMPLE 3

### The Paper Industry

i) The inflammability of paper (such as conventional writing paper, melamine coated paper, wall paper, cardboard, and other similar papers) may be reduced by treating it with an aqueous solution of a composition of the invention. The inflammability of paper may also be reduced by treating the fibres used to make the paper with an aqueous solution of a composition of the invention before they are pressed together. Preferred compositions according to the invention for treating paper comprise 2 to 4% boric acid, 3 to 5% borax, 1% ammonium nitrate, by weight of the composition, and water.

### EXAMPLE 4

### The Electronics Industry

i) The inflammability of printed circuit boards made from textile and resin may be reduced by treating the textile use to make the circuit boards with an aqueous solution of a composition of the invention.
Preferred compositions according to the invention for treating textiles used for making printed circuit boards comprise 2 to 4% boric acid, 3 to 4.5% borax, l to 2% ammonium nitrate, by weight of the composition, and water.
ii) The inflammability of electrical isolators made from paper and resin may be reduced by treating the paper used to make the isolators with an aqueous solution of a composition of the invention.
Preferred compositions according to the invention for treating paper used to make electrical isolators comprise 2 to 4% boric acid, 3 to 5% borax, 1% ammonium nitrate, by weight of the composition, and water.

### EXAMPLE 5

### The Paint Industry

i) The inflammability of paint suitable for painting plastics may be reduced by mixing the powdered components used to make the paint with an aqueous solution of a composition of the invention and then adding the remaining components of the paint.
ii) Preferred compositions according to the invention for reducing the inflammability of such paint comprise 2 to 4% boric acid, 3 to 5% borax, 1% ammonium nitrate, by weight of the composition, and water.

### EXAMPLE 6

### The Cable Industry

All kind of papers and textiles which are used by the cable Industry can be mixed with the liquid solution in order to prevent the spread of fire from inside of the cable to outside and vice versa—specific usage will be indoor cabling and tunnel applications—to prevent spread of fire in an enclosed area.

### EXAMPLE 7

### The Automobile industry

All inflammable material used in car industry such as upholstery, floor coverings. Wall & top coverings, card boards and fiberboard layers can be protected with this solution in the event of fire.

### EXAMPLE 8

### The Aircraft Industry:

The invention can be applied to various components of an aircraft, such as the fittings, furnishings, wires, etc. where fire proofing has to meet the highest standard.

Additionally the following standard tests were performed on samples treated with the proper composition of the invention and successfully passed all requirements:

BS EN 20105_BO 2: 1993 Light fastness testing

BS 7837: 1996 Fire test on Fabric

BS EN ISO 105-X 12: 1995 Color fastness to Rubbing

BS EN ISO 105-DO 1: 1995 Color fastness to dry cleaning

EN ISO 6468 esticides and PCB's for Paper, Woods, Textile

EN ISO 10301 highly volatile halogenated hydrocarbons for Paper, Wood: Textile

GC/NP-FID flame retardant for Paper, Woods, Textile

BS 5867 part 2: 1980 Fire tests on fabric for Paper, Woods, Textile

Energy dispersive X-ray analysis Elements for Paper, Woods, Textile

1. A composition for reducing the inflammability of a substrate, the composition comprising boric acid, borax and ammonium nitrate.

2. A composition according to claim 1 in which the boric acid is present at about 2% to about 6%, preferably about 2% to about 4.5%, by weight of the composition.

3. A composition according to claim 1 or 2 in which the borax is present at about 3% to about 8%, preferably about 3% to about 6%, by weight of the composition.

4. A composition according to any preceding claim in which the ammonium nitrate is present up to about 3%, preferably at about 1% to about 3%, more preferably at about 1% to about 2%, by weight of the composition.

5. A composition according to any preceding claim in aqueous solution.

6. A method for making a composition according to, claim 5 which comprises sequentially dissolving, at least partially, each component of the composition to form the aqueous solution.

7. A method for making a composition according to claim 5 which comprises dissolving, at least partially, each component of the composition in a separate aliquot of water and then combining the separate aliquots to form the aqueous solution.

8. A method for reducing the inflammability of a substrate which comprises contacting a composition according to any of claims 1 to 4 with the substrate.

9. A method according to claim 8 in which the composition is in aqueous solution.

10. A method according to claim 9 which further comprises making the composition using a method according to claim 6 or 8.

11. A method according to any of claims 8 to 10 in which the composition is contacted with the substrate at a temperature above room temperature, preferably between 20 DEG C. and 90 DEG C.

12. Use of a composition according to any of claims 1 to 5 for reducing the inflammability of a substrate.
